(19) United States
(12) Patent Application Publication
(10) Pub. No.: US 2005/0044935 A1
(43) Pub. Date: Mar. 3, 2005

(54) Integrated pressure sensor and carbon canister purge valve for vehicle engine

(76) Inventors: Leonel A. Barrera, Cd. Juarez Chihuahua (MX); Bradley Scott Farrenkopf, El Paso, TX (US)

Correspondence Address: DELPHI TECHNOLOGIES, INC., M/C 480-410-202, PO BOX 5052, TROY, MI, 48007, US

(21) Appl. No.: 10/649,453

(22) Filed: Aug. 26, 2003

(51) Int. Cl. G01M 19/00

(52) U.S. Cl. 73/118.1

(57) ABSTRACT

An integrated space-saving purge valve/pressure sensor assembly includes a purge valve connectable between a carbon canister and an engine intake that opens when the engine is running at speed and temperature to purge fuel vapor trapped in the canister. A pressure sensor is mounted on the valve housing and communicates with the interior of the housing through an orifice, such that the signal from the sensor represents the pressure in the purge system. The signal can be sent to the engine control module (ECM) for further processing.

### FIELD OF THE INVENTION

The present invention relates generally to vehicle fuel vapor control systems.

### BACKGROUND OF THE INVENTION

As recognized by the present invention, carbon canisters can be provided in vehicles to trap hydrocarbon fumes from the gas tank when the engine is not running. In this way, the environment is protected from fuel vapor leak off when the engine is off. To prolong the useful life of the canister, the present invention understands that when the engine is running the canister can be purged by opening a valve between the canister and engine intake to establish a path through which hydrocarbons in the canister can be drawn into the engine and burned.

In addition to the above observations, the present invention further understands that to ensure that the above-described fuel vapor trap system has not developed leaks, which would defeat the purpose of the system, a pressure sensor can be used to generate a signal which can be used by an engine control module (ECM) to determine whether system integrity has been lost. The present invention further understands that the sensor may be mounted in a location, e.g., the fuel tank, in which space is at a premium. As understood herein, space in a vehicle, typically at a premium, can be conserved using the solutions set forth herein.

### SUMMARY OF THE INVENTION

A valve assembly includes a valve housing connectable to an intake of an engine and to a carbon canister to selectively establish fluid communication therebetween. The housing defines an interior cavity. A pressure sensor is supported on the valve housing and communicates with the cavity. As set forth further below, the sensor outputs a signal representative of pressure in the cavity. In a preferred embodiment, the pressure sensor may be electrically connected to a computing apparatus on a vehicle supporting the engine that can generate a warning signal if the signal reaches a threshold.

In the particularly preferred embodiment set forth below, the valve housing can define an interior guidance rib, and the rib is formed with an orifice through which the sensor communicates with the cavity. The preferred pressure sensor can be enclosed in a sensor housing that is on the valve housing and that, if desired, can be made integrally with the valve housing.

In another aspect, a fuel vapor purge system is disclosed for an engine having an associated fuel tank, an intake, and means for trapping fuel vapor from the fuel tank when the engine is not operating. The purge system includes means for selectively establishing fluid communication between the trapping means and the intake when the engine is operating to purge the trapping means. Also, the system includes leak sensing means supported on the trapping means for outputting a signal representative of whether a leak to exists in the purge system.

In still another aspect, a purge valve for an engine fuel vapor recovery system includes a valve housing that defines a cavity which holds a valve. The valve housing is formed with a carbon canister port connectable to a carbon canister line. The valve housing also has an engine intake port connectable to an engine intake line. A valve is in the valve housing and is movable between an open configuration, wherein fluid communication between the intake and the canister is established, and a closed configuration, wherein fluid communication between the intake and the canister is not established. Also, a pressure sensor is supported by the valve housing. The pressure sensor communicates with the cavity for generating a signal representative of pressure in the cavity.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of the purge valve assembly of the present invention, with portions cut away to schematically show the valve inside the valve housing and schematically showing ancillary components;

FIG. 2 is a cross-sectional view as seen along the line 2-2 in FIG. 1, with portions cut away for clarity; and

FIG. 3 is a perspective cut-away view showing the orifice in the rib of the valve housing.

### DETAILED DESCRIPTION OF THE PREFERRED EMBODIMENT

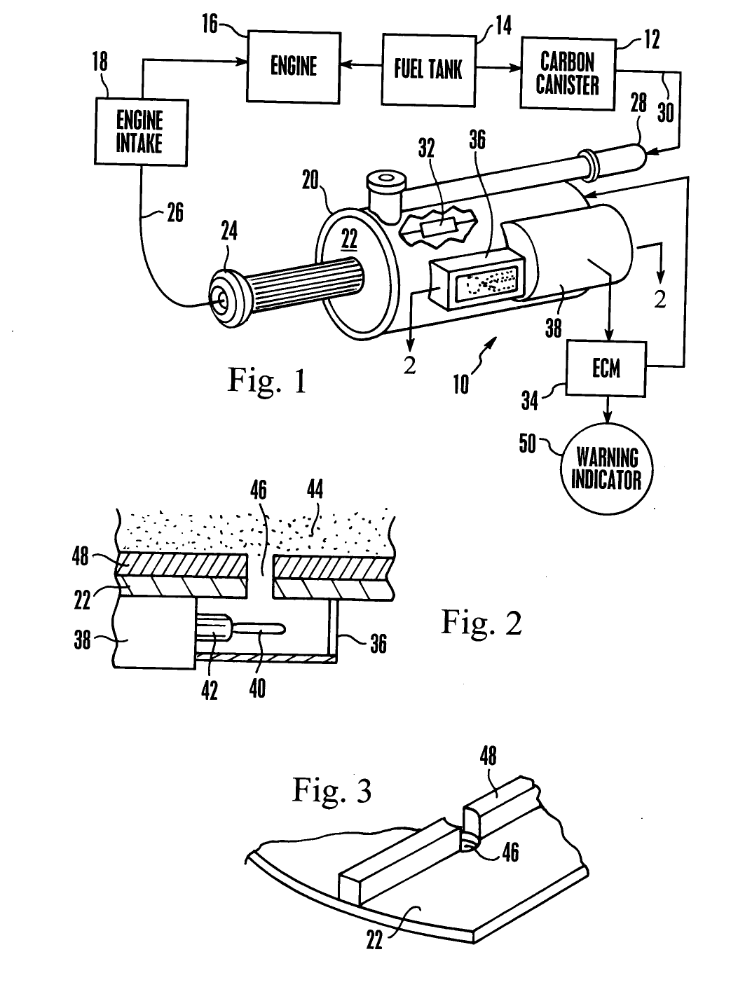

Referring initially to FIG. 1, a carbon canister purge system is shown, generally designated 10, for purging, from a carbon canister 12, fuel vapor from a fuel tank 14 that has been trapped in the carbon canister 12 when an associated engine 16 is not operating. The purge system 10 works by selectively establishing a pathway for fluid communication between the carbon canister 12 and an intake 18 of the engine 16 when the engine 16 is operating and has reached a predetermined speed and temperature. In this way, the engine draws in and combusts fuel vapor from the canister 12 to thereby purge the canister 12 and prolong its useful life.

In the preferred embodiment shown, the system 10 includes a purge valve assembly 20 that has a hollow metal or plastic valve housing 22 formed with an engine intake port 24. As shown, the engine intake port 24 can be connected to an engine intake line 26 to connect the port 24 to the engine intake 18. Also, the valve housing 22 has a carbon canister port 28 that can be connected to the carbon canister 12 by a carbon canister line 30.

Within the valve housing 22 and interposed between the ports 24, 28 is a valve 32. The valve 32 may be a plunger-type coil operated valve that moves, in response to control signals from a processor such as an engine control module (ECM) 34, between an open configuration, wherein fluid communication between the engine intake 18 and the carbon canister 12 is established, and a closed configuration, wherein fluid communication between the intake 18 and the canister 12 is blocked. In one non-limiting embodiment the valve 32 may be an enhanced precision purge (EPP) valve made by Delphi Automotive Systems.

In accordance with the present invention, a pressure sensor housing 36 is supported by the valve housing 22. The pressure sensor housing 36 contains a pressure sensor that senses pressure in the valve housing 22 as discussed further below, and that is connected by a sensor connector assembly 38 to a processor such as the ECM 34. If desired, the pressure sensor housing 36 may be made integrally with the valve housing 22. Or, the pressure sensor housing 36 may be made separately from the valve housing 22 and then bonded or fastened to the valve housing 22.

FIGS. 2 and 3 show details of the pressure sensor of the present invention. As shown best in FIG. 2, a pressure sensor 40 is mounted in the sensor housing 36. The pressure sensor 40 may include a low pressure sensing element on an integrated circuit chip that is potted using epoxy resin to the sensor housing 36. In one preferred non-limiting embodiment the sensor 40 may be a sensor marketed by the present assignee under the trademark “Intellek”. The present assignee's U.S. Pat. No. 6,227,055 describes a non-limiting pressure sensor that can be used as the sensor 40. The sensor 40 is connected by leads 42 to the connector 38 and, thence, to the ECM 34.

In cross-reference to FIGS. 2 and 3, the valve housing 22 defines a cavity 44, and the pressure sensor 40 communicates with the cavity 44 through an orifice 46. In the preferred embodiment, the valve housing 22 is formed with a guidance rib 48, and the orifice 46 is formed through both the wall of the valve housing 22 and the guidance rib 48 as shown. As understood by the present invention, by forming the orifice 46 through the guidance rib 48, the pressure sensor 40 is better shielded from any turbulence-induced pressure fluctuations that might exist within the cavity 44, facilitating a more constant and true pressure signal output. The size of the orifice 46 is established to be sufficiently large to equalize pressure between the housings 22, 36 while minimizing the transfer of pressure fluctuations from the cavity 44 to the sensor 40.

The signal from the pressure sensor 40 can be sent to the ECM 34 as an indication of the presence or absence of leaks in the purge system. The ECM 34 can generate a warning signal if the signal reaches a threshold indicating a leak, and the warning signal can be used, e.g., to activate an audio or visual warning alarm 50 and/or to control operation of the purge system as appropriate in the presence of a leak.

While the particular INTEGRATED PRESSURE SENSOR AND CARBON CANISTER PURGE VALVE FOR VEHICLE ENGINE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A valve assembly, comprising:
a valve housing connectable to an intake of an engine and to a carbon canister to selectively establish fluid communication therebetween, the housing defining at least one interior cavity; and
a pressure sensor supported on the valve housing and communicating with the cavity, the sensor outputting a signal representative of pressure in the cavity.

2. The valve assembly of claim 1, wherein the pressure sensor is electrically connected to a computing apparatus on a vehicle supporting the engine.

3. The valve assembly of claim 1, wherein the valve housing defines an interior guidance rib, and the rib is formed with an orifice through which the sensor communicates with the cavity.

4. The valve assembly of claim 1, wherein the valve housing holds a valve movable between an open configuration, wherein fluid communication between the intake and the canister is established, and a closed configuration, wherein fluid communication between the intake and the canister is not established.

5. The valve assembly of claim 1, wherein the signal from the sensor is sent to a processor for generating a warning signal if the signal reaches a threshold.

6. The valve assembly of claim 1, wherein the pressure sensor is enclosed in a sensor housing and the sensor housing is on the valve housing.

7. The valve assembly of claim 6, wherein the sensor housing is made integrally with the valve housing.

8. A fuel vapor purge system for an engine having an associated fuel tank, an intake, and means for trapping fuel vapor from the fuel tank at least when the engine is not operating, the purge system comprising:
means for selectively establishing fluid communication between the trapping means and the intake when the engine is operating; and
leak sensing means supported on the selectively establishing means for outputting a signal representative of whether a leak exists in the purge system.

9. The system of claim 8, wherein the trapping means is established by a carbon canister and the means for selectively establishing is established by a purge valve having a valve housing defining a cavity and holding valve means movable between an open configuration, wherein fluid communication between the intake and the canister is established, and a closed configuration, wherein fluid communication between the intake and the canister is not established.

10. The system of claim 9, wherein the leak sensing means is a pressure sensor supported on the valve housing and communicating with the cavity, the sensor outputting a signal representative of pressure in the cavity.

11. The system of claim 10, wherein the pressure sensor is electrically connected to a computing apparatus on a vehicle supporting the engine.

12. The system of claim 10, wherein the valve housing defines an interior guidance rib, and the rib is formed with an orifice through which the sensor communicates with the cavity.

13. The system of claim 10, wherein the signal from the sensor is sent to a processor for generating a warning signal if the signal reaches a threshold.

14. The system of claim 10, wherein the pressure sensor is enclosed in a sensor housing and the sensor housing is on the valve housing.

15. The system of claim 14, wherein the sensor housing is made integrally with the valve housing.

16. A purge valve for an engine fuel vapor recovery system, comprising:
a valve housing defining a cavity and holding a valve therein, the valve housing being formed with a carbon canister port connectable to a carbon canister line and an engine intake port connectable to an engine intake line;
a valve in the valve housing and movable between an open configuration, wherein fluid communication between the intake and the canister is established, and a closed configuration, wherein fluid communication between the intake and the canister is not established; and
a pressure sensor supported by the valve housing and communicating with the cavity for generating a signal representative of pressure in the cavity.

17. The purge valve of claim 16, wherein the valve housing defines an interior guidance rib, and the rib is formed with an orifice through which the sensor communicates with the cavity.

18. The purge valve of claim 17, wherein the pressure sensor is enclosed in a sensor housing and the sensor housing is on the valve housing.

19. The purge valve of claim 18, wherein the sensor housing is made integrally with the valve housing.
